(19) United States
(12) Patent Application Publication
(10) Pub. No.: US 2004/0139153 A1
(43) Pub. Date: Jul. 15, 2004

(54) Computer and/or software architecture using microkernel and multi-tier concept with component technology

(75) Inventor: Gert Heidenreich, Weinstadt (DE)

Correspondence Address: MORRISON & FOERSTER LLP, 1650 TYSONS BOULEVARD, SUITE 300, MCLEAN, VA, 22102, US

(73) Assignee: Siemens Aktiengesellschaft, Munchen (DE)

(21) Appl. No.: 10/667,890

(22) Filed: Sep. 23, 2003

(30) Foreign Application Priority Data
Sep. 24, 2002 (DE) 102 44 459.5

(51) Int. Cl. G06F 15/16

(52) U.S. Cl. 709/203

(57) ABSTRACT

The invention relates to a method and a system for a computer architecture for distributed client/server systems. The system is organized according to a multi-tier model and comprises at least one first presentation layer, a second layer and a third data layer. The second layer is organized as a microkernel-based client/server system. An interface in the form of a message is specified between the first and second layer, with a server request consisting of at least the following: the client generates a message and sends the message to the server. If necessary, the request is forwarded and processed in full. The result of the request is sent back on the basis of the message.

### CLAIM FOR PRIORITY

This application claims priority to application DE 10244459.5, filed on Sep. 24, 2002 in the German language, the contents of which are hereby incorporated by reference.

### TECHNICAL FIELD OF THE INVENTION

The invention relates to a computer architecture for execution of software applications and a method and a system for the control and/or organization of an application process in a distributed system with at least one client and at least one server.

### BACKGROUND OF THE INVENTION

As the development of software is invariably expensive and subject to changes at short notice, an architecture should be chosen that takes account of the following:

supports modularization in the form of small software components,

permits easy communication between the components,

is aligned with industry standards with the aim of allowing the use of third-party software,

enables scaling by means of a variable number of computers with administration overhead, and

adaptability to specific customer profiles is possible with administration overhead,

assurance of the functionality and usability of old code and

support for a powerful patching concept.

The pure client/server structure should be mentioned at this juncture as an earlier approach. With this, the presentation layer represents the database client and the data layer represents the database management system (DBMS). In this case, the separation (modularization) of graphics and data processing resulted in SQL statements being used at the presentation level and problem-specific code needing to be implemented at the data level with the aid of stored procedures and pass-through techniques.

Although this permits very quick solutions, when software changes are required there are many different places in the program sources at which the consequences of the change (so-called side-effects) must be taken into account. This proves to be very error-prone.

In practice, it is disadvantageous that the inter-communicating processes of the client, on the one hand, and the server, on the other, need to know a great deal about one another in order to enable problem-free data transfer. This, in turn, leads disadvantageously to a high number of explicit interventions in the case of changes or adaptations in respect of, say, validity or access rights.

In this model according to the prior art, the asynchronous response to a database query can be implemented via a callback interface. With this, the call point of the function is also passed to the DBMS via the client-side call, and the function then receives the results. First, however, the DBMS must provide the caller with information on the type of callback interface expected. It proves to be disadvantageous, however, that the setting up of a callback function represents a considerable overhead, which then grows if a distributed application is involved and references or pointers have additionally to be administered across computer boundaries.

All these problems led in the prior art to a different approach, the multi-tier model, which permits callbacks to be dispensed with.

A multi-tier architecture contains at least 3 layers (called tiers in this context):

a first layer, the presentation layer, containing the graphics components,

a second, middle layer (also called the middle tier) containing the business logic, and

a third data layer containing the databases.

The three layers communicate via interfaces by processing calls from “top to bottom”—in other words, from the first down to the third layer. Following processing, the respective responses are passed from bottom to top again as so-called return values.

It has proved to be problematical here that the active part of the process of the calling component (a so-called thread) of the first layer remains blocked until the result from the third layer, i.e. in most cases the result of a database query, has been received.

In this case, all processes relating to the third layer, i.e. database-specific code, are withdrawn into the middle layer in order to achieve a separation from the DBMS. The disadvantage is that changes during access to the database must now be made in multiple components.

Another approach for an operating system architecture is the theoretical work done on the MACH model developed by the Carnegie Mellon University. This model is based on a microkernel approach and requires a consistent client/server structure. In this model the kernel, or core, contains only clients, whereas the periphery comprises the full services, i.e. the servers. If one server requires the services of another server, it sends a request through the microkernel. This concept is used for operating systems and their processes, such as interprocess communication or file management strategies, for example. With regard to the organization of application processes, however, it does not yet support the necessary separation between the different layers.

In order to avoid the aforementioned disadvantages and preserve the advantageous and desired separation of the individual layers of the multi-tier model, it is desirable to develop this further to the extent that the middle layer is organized on a decentralized basis via peer-ranking software components.

### SUMMARY OF THE INVENTION

The invention discloses a software architecture for an application process which combines the advantages of the multi-tier concept and those of the microkernel principle.

In one embodiment of the invention, a second layer preferably includes at least one server and is organized as a microkernel-based client/server system and in which an interface in the form of a message is specified between the first and second layer, where a server request consists of at least the following:

the client translates the server request into message with the relevant arguments,

the client sends the message to the server preferably from the middle layer,

the request is forwarded if necessary and fully processed, and

the result of the request is returned by means of the message.

In keeping with the structure according to the invention, the second layer, or the middle tier, is configured for routing the server request and requires no client-specific knowledge.

The server request, which generally includes a query (to a database) and a response (result of the database query), is divided according to the invention into a “question transaction” (a first transaction)—originating from the client to the server—and in an “answer transaction” (second transation)—originating from the server to the client. These are physically separated from each other, with the result that the messages are kept fully asynchronous with respect to one another.

In a preferred embodiment of the invention, the client belongs to the first layer and the server to the second and/or third layer. After processing the request, the server returns a result of the request to the calling client or to another destination address. In this case the return address of the server request is contained in the message.

According to the invention, the middle tier is implemented in its entirety in the microkernel. The servers implement the services of the system. The message of a client from the first layer is sent to a root component of the microkernel of the second layer, which then forwards the message to a processing component. Preferably, the microkernel of the second layer includes multiple subsystems which, in turn, are subdivided into one or more components. This leads advantageously to a high degree of modularity and makes the system flexible to the extent that the service provided by a server can be distributed over a number of components without there being an increase in the address administration overhead.

An advantage can also be seen in the fact that services or service servers can also be removed, modified or added during operation, and that old application code can be integrated into the system without restrictions.

An advantage lies in the transparent inter-module communication. As a result of the specification of an interface according to the invention, a participating developer, for example, does not need to be concerned with the communication with other modules. The cross-tier platform is the specification of the messages. This is oriented toward colloquial language and requires no additional knowledge.

An important point is the use of asynchronicity in the inter-communication, without the need to rely on callbacks. These represent an error-prone area, for which, moreover, in-depth knowledge and complicated development tools are required.

Owing to the asynchronicity of the messages, many message-passing actions are possible simultaneously in order to increase the responsiveness of the system. However, this leads to the simultaneous calling of the components by different threads. Normally, these must be synchronized. Since only a reading query to the database, the so-called routing database, and the recopying of the arguments are carried out in the components of the second layer or in the so-called business logic components, no thread synchronization is necessary in this case. Only local function data belonging to a thread context is used. This permits the use of COM objects in the multi-threaded apartment (MTA) in Windows-based systems.

Since the message destination is already specified in the sending service server, no further point is involved in so far as the destination planning is concerned. It is possible from any server to initiate a communication between two other servers, as this information is copied transparently by the system along with the message.

The distribution capability and scalability of the multi-tier and microkernel approaches are improved by the late routing. Administrators can modify the distribution of the components across different servers at any time without requiring any knowledge of the inner workings of the service servers.

A further advantage of the message path lies in the potential use of identical commands for different service servers or with different data fields.

Over time new service servers can be added. These can then use the services of the other servers via the existing infrastructure without the developers being required to know the source texts in detail. By using the existing messages, they can integrate the new elements seamlessly into the overall system.

In a preferred embodiment of the invention, the mandatory interface specification in the form of a message is of the “string” type and is passed on by means of the arguments of the interface functions. A message is passed with the corresponding arguments of the function of the called interface being supplied by the caller. This means that from the viewpoint of the caller the message passing is completed in its entirety and terminated.

The content of the messages is the object of the specification of the respective application. However, this must not only specify the contents of the command and the data field; it must also describe the corresponding syntax. In this embodiment the message has the following structure: “category+subsystem+command-group+command+timestamp+control-field+origin+source-name+destination-name+user-data” Each string, separated by the plus sign, is a discrete argument of the interface functions. This ensures that the string manipulations to acquire the information are reduced to a minimum.

### BRIEF DESCRIPTION OF THE DRAWINGS

Further advantages, features and alternative embodiments of the invention, not to be interpreted as constraining, can be found in the following detailed description of the Figures, which should be read in conjunction with the drawings in which:

FIG. 1 shows a known multi-tier architecture from the prior art.

FIG. 2 shows different components of a second layer of a microkernel according to the invention.

FIG. 3 shows an organization according to the invention.

FIG. 4 shows a typical representation of a question and answer transaction of a service server request.

FIG. 5 shows a flowchart of the method according to the invention.

### DETAILED DESCRIPTION OF THE INVENTION

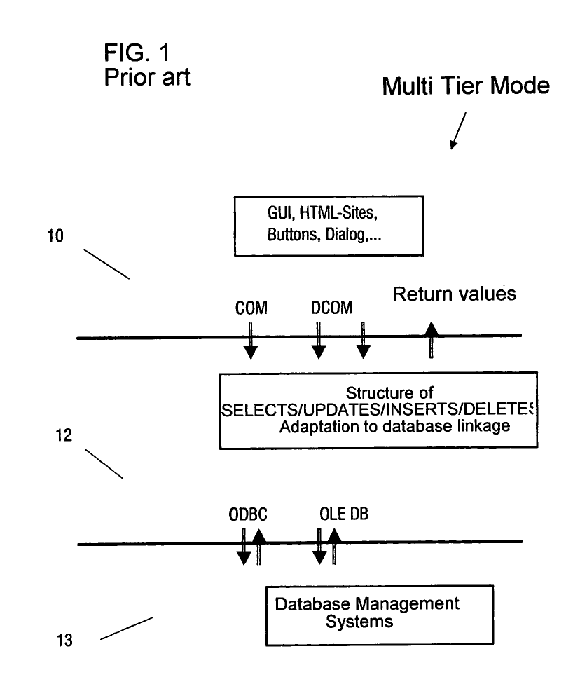

FIG. 1 shows the basic multi-tier model known from the prior art, including in this case of three layers (also called tiers): a first presentation layer 10, a second or middle layer 12, and a third data layer 13. In Microsoft-based systems, first-layer calls to the second layer are made via COM or DCOM interfaces. The responses take the form of return values of the corresponding COM or DCOM call. The second layer 12 serves to generate database queries, e.g. SQL queries, and should therefore know the structure of the third layer. The third layer 13 includes the data and a database management system. A disadvantage with this structure from the prior art is that an active part of a client process, a so-called thread, remains blocked until the database access is terminated. This leads to long wait times and a reduction in overall system performance.

In the solution according to the invention, the separation of the processes between the individual tiers 10, 12, 13 has likewise been retained. However, the middle tier or middle layer 12 is organized differently—that is to say, according to a microkernel principle. For this, a fixed interface in the form of a message 14 was developed for the middle tier 12. Moreover, according to the invention, (modular) components are used which implement at least parts of a server service.

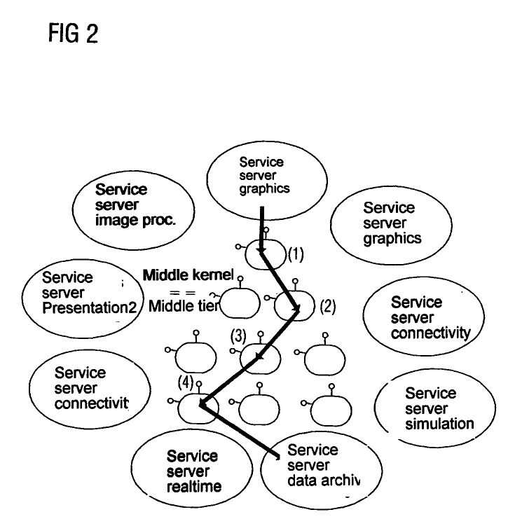

With reference to FIG. 2, the basic structure according to the invention is explained below. The combination of the multi-tier approach and the microkernel principle uses a temporary role change (from recipient to sender) between client C and server S. The middle tier 12 is implemented entirely in the microkernel, whereby the satellites around it can originate either from the first layer 10 or from the data layer 13 and are also called subsystems. Generally speaking, they implement the services.

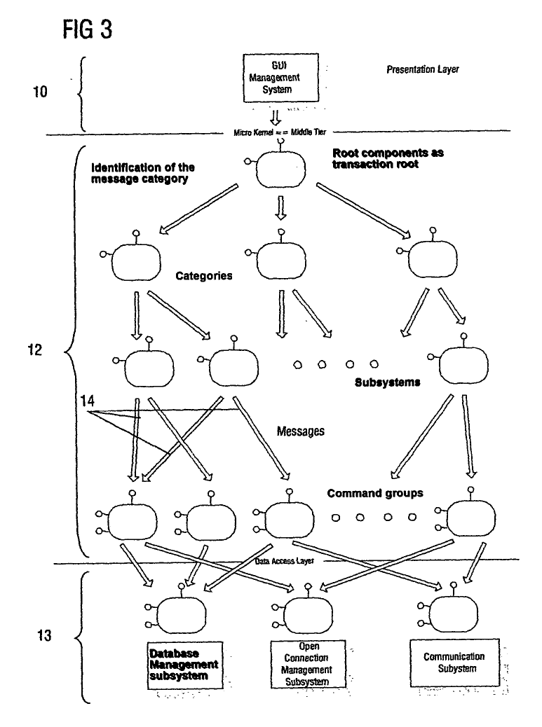

As shown in FIG. 3, the microkernel is based on a strict client/server architecture. Client C submits a request in the form of a message 14 and then terminates the call. Client C is then free again and can handle further processes.

The request is processed by the selected subsystem, without the requesting subsystem or the middle layer 12 remaining blocked, since the request has, of course, been passed to the executing subsystem. Once the requested subsystem has finished processing message 14, it now becomes, in turn, the requesting subsystem or client C and calls a destination subsystem in exactly the same way (e.g. the original requesting subsystem), in order to send off its results also via message passing. This completes an information cycle which, according to the invention, is subdivided into two transactions—a question transaction and an answer transaction. A transaction can be visualized as a spur line.

The flexibility according to the invention stems from the fact that the entire communication includes these two spur lines/transactions, i.e. the question transaction and the answer transaction. A logical link exists between the two.

Usually, the answer transaction goes to the original client, client C, that submitted the question transaction. However, it is also possible for the answer transaction to be sent to a different destination address. Routing is handled by the microkernel by means of the business logic, which is implemented consistently by means of components. Routing is performed on the basis of a database, the routing database. It is therefore possible to adapt or extend message passing even during operation.

A spur line/transaction remains in existence until its end has been declared. The partition into a question/answer transaction results in two transactions. It is advantageous that the time they remain blocked depends not on the requested service, but only on technical factors such as, for example, the network connections, the number of computers or the computing performance.

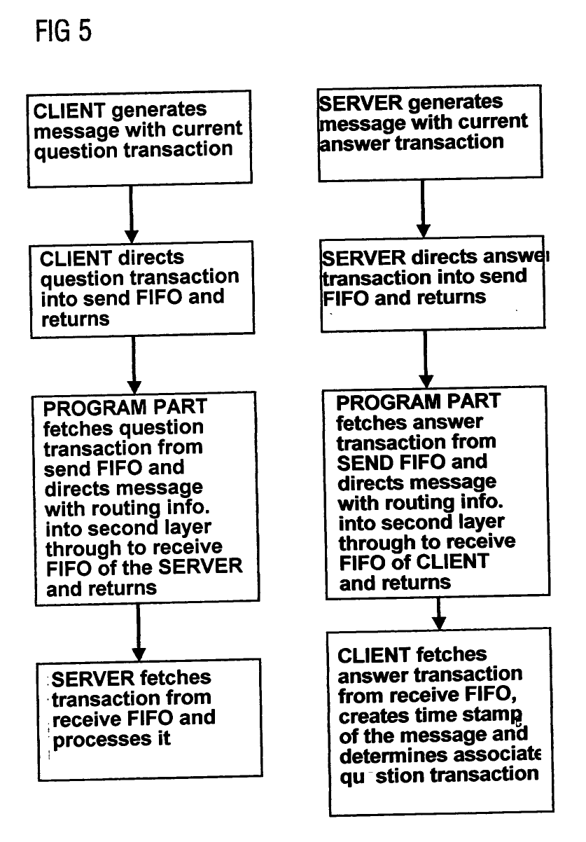

FIG. 5 shows a flowchart which explains the basic sequence of the procedure according to the invention:

The left side of this figure depicts the actions of client C, a program section and server S relating to the question transaction, while the actions relating to the answer transaction are shown on the right.

A client C now requires certain data from the data layer 13 and generates a message 14 using these current arguments. At this time this message relates to the question transaction. Client C then pushes message 14 into the send queue of client C, which is organized according to the FIFO

(First-In/First-Out) principle, and returns. The addressed program section now fetches the topmost element in the queue and routes message 14 using the coded routing information through the second layer from server S to server S as far as a receive FIFO of server S and then returns. Server S can now read out message 14 or the question part from the receive queue and process it. This completes the first section of the server request according to the invention. The result is now be sent back again to the original client C or to a different destination address. Toward that end, server S in turn generates a message 14 according to the same principle; in this case the message codes the answer transaction and places it in the send FIFO of server S, returning subsequently. The program section can now read out the answer transaction from the send FIFO and, on the basis of the routing information, route it through to the receive FIFO of client C in the second layer 12, returning subsequently.

Client C fetches message 14 from the receive FIFO of client C and records the timestamp that uniquely identifies message 14. Via the timestamp to millisecond accuracy, client C can unequivocally identify the associated question transaction and, as it were, assemble the two-part structure (question-answer) into a single-part structure (request). The entire request is now completed.

Communication with regard to the calls is implemented using component technology. This entails a component “client” calling a component “server” via its public interface. The program is then implemented by means of an appended and encapsulated component class. The term “public” in relation to the interface means that it acquires a definition that is visible globally in any computer, uniquely identifies it and can also be interrogated across computer boundaries. This is achieved through the use of GUIDs (Globally Unique Identifier) for the interface, the component class, resources, etc.

An interface represents a collection of functions with call parameters. Basically, these can take on any type. In the preferred embodiment, “string” is used as a general default type. This provides a generic type which permits message passing suitable for any conceivable developments. This is implemented by means of a call to a component via one of its functions, which is then blocked until it is terminated. Within this function, the passed message is converted and interpreted. Only after this has taken place does it return the program flow back to the caller.

Message passing is implemented by means of “textual messages”. It is implemented by the text code that is native to the particular destination platform. With Windows and many UNIX platforms, this is UNICODE. A message is made up of several parts which are distinguished by the fact that they either occur as a separate argument or are assembled into a string with a defined separator, as follows:

“category.subsystem.command-group.command+data-field”.

The data field is generally composed of the following substrings: source-name|control-field|user-data.

By way of abbreviation the following is agreed: The “category.subsystem.command-group” part of the message is called the “message path”. The “command+data-field” part receives the name “token”, since it is passed through the system unchanged.

Thus, a message 14 is made up of message path and token.

The message path implements a hierarchy which specifies a relational tie that enables unique routing from the root through to the destination. As is usual in relational ties, the uniqueness applies only from left to right in the message path, or from top to bottom. The message path denotes a destination that is identical with a subsystem. The token is delivered to this subsystem.

This hierarchy identifies the keys of a routing database. The key category represents the first level of the hierarchy. Once it has been identified, a further branch is specified on the second level by the subsystem key. The command group branches as the third level and enables the last branch, which is specified by the command in the token itself. Thus, based on the model of a hierarchical file system, this results in a kind of directory which permits unique identification of a file, corresponding in this analogy to the token. The uniquely identifiable keys are used to store the corresponding call information of the different components of the next lower level in each case.

An advantage of adding a message path lies in the potential use of identical commands for different subsystems or commands with different data fields. The message path can be implemented via an external database.

Each level is implemented by a component in the middle tier 12 or microkernel. The information required to call a software component is stored under an identifiable key.

There is one component for each key. These routing components together represent the business logic in the microkernel or middle tier 12. These components need to be developed only once. There are a number of tools available to assist with this. In the case of MS Com there are Visual Basic or Visual C++ and ATL.

Since multiple spur lines are operated in parallel, some routing components can potentially be called in different threads simultaneously. This is a classic case for thread synchronization. In the case of the architecture according to the invention, it is dispensed with completely, in that on the one hand locally generated data and resources are used and global data is only read. In C++, this would be the automatic variables and the class attributes.

This results in the multi-threaded apartment (MTA) type being used in MS Com. In this case it is the responsibility of the component whether it synchronizes its attributes (global component data) since in any event each thread enters the component. In the case of this architecture they are used for reading at most, so the entering thread is not blocked anywhere. This leads to an optimal granularity, which extends down into the thread change times.

In order to be able to use the work of object request brokers such as MTS/Com+ or CORBA, the components of the microkernel must be aware of the “just-in-time activation” of these brokers. The consequence of this is that the aforementioned automatic variables or resources have to be specially generated and released. This differs fundamentally from the constructor/destructor approach of the class concept.

If new routes are to be added, no program text has to be changed, since the calls are resolved via the routing DB at the runtime of the components. This presupposes a successful agreement between the subsystems, since the token includes quite specific data through which errors may be triggered. But here, too, the middle tier 12 can help in visualizing errors. As the entire message 14 includes the data type “text”, it can be checked at any time and on any level in plaintext, i.e. unencrypted. For example, if the data field of a token which is to execute a query to a database by means of “Select” is filled with the complete Select string, this currently generated one can be viewed in plaintext format.

New commands are added by including a new entry in the routing database. The implementation then takes place in the two subsystems that want to speak to each other via the messages 14.

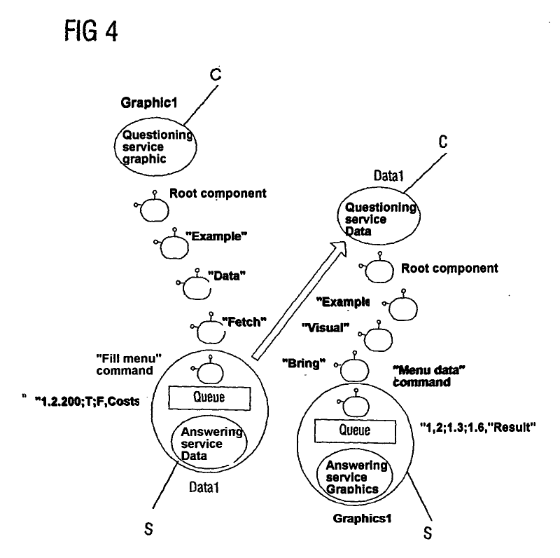

The following example is intended to show, in connection with FIG. 4, how the message passing is implemented in the architecture according to the invention.

The starting point is a requesting subsystem “Graphics”, which is to implement a mask. This mask requests all the information necessary to represent a certain set of hits. The Graphics subsystem uses it to generate a SQL Select string for the data field and combines it with a previously specified command associated with a token “Get.Graphics.0.SELECT . . . ”, where “Graphics” is the name of the sending subsystem and “0” is the content of the control field.

In order to be able to direct the token to the right destination, the message path is now specified: “Example.Visual.Fetch”. This, too, is the object of the preceding specifications. These are independent of the architecture described here.

Thus, the complete call looks like: “Example.Visual.Fetch.Get.Graphics.0.SELECT . . . ”.

These strings call a root component of the microkernel. This is the standard interprocess communication, which is the same in transitions between the layers or from a subsystem to the microkernel. The same root component is called every time, and this is the default entry point of a call chain or spur line, as described below. It is also the so-called transaction root, i.e. this is where the transaction begins.

Its first action consists in interpreting the message path. In this case the category “Example” serves as a key to enable the call information for the next lower component to be requested from the routing database. This component is then also called immediately, with the message path and the token simply being passed through.

This component from the category level operates according to the same principle as the root component: interpret the message path (“Visual”), search the routing database for the key, and acquire the call information. The result is the call to a component from the next level down, called “Subsystem”. This component now operates in its turn according to the same principle and in turn calls a component “Fetch” from the command group level.

Overall, a request is converted into recursive calls to the respective servers S. Each level can contain an indefinite number of components. This is also the reason why the call path is only unique from top to bottom, and not vice versa. The command group level is the direct call layer of the subsystems. It includes the clients C of the subsystems and is the boundary between the middle tier (or microkernel) 12 and a subsystem.

In these components, in contrast to those above, the command is not interpreted any further. The token in the example “Get.Graphics.0.SELECT.” is passed on in this form to the subsystem. The message path must therefore ensure that multiple commands of the same type are processed by the same subsystem. This final component of the microkernel knows implicitly how the special subsystem has to be called, or explicitly fetches the information (GUID). This means that it is advantageous to implement one corresponding component on the command group level for each subsystem, since it then does not need to concern itself with a query to the routing database. In this case, implicit knowledge is necessary, since no information about the destination subsystem is contained in the token itself. This is present in the message path. Consequently, in the implementation of a new message, no code is required in the middle layer 12, while the code has to be implemented in the subsystems.

The command “Get.Graphics.0. SELECT . . . ” with its Select string in the data field is now passed on to the corresponding subsystem “Data”. If this should be the wrong subsystem, the error lies in the message path which performs the routing. The sending to the subsystem again runs via a component call. The subsystem is called as a server from the component of the command group level. For this, the subsystem should be a component with interface. The Class component serves to establish a separation with respect to the middle tier 12. This component is called directly via the interface and serves to store the received information in a queue and signal its arrival to the remaining subsystem. The remaining subsystem runs in at least one worker thread in order to possess an independent execution path. This allows the Class component to terminate immediately and thereby successfully conclude the transaction.

Upon arrival in the Data subsystem, the spur line or transaction is completed and the participating components also terminate successfully. As this is only half of the action necessary to process the request, a response should be routed back again. This now happens in the same way as the question was delivered. At this point the microkernel principle is applied. Contrary to the multi-tier model, in this case each subsystem can become the top level and send a command to the bottom level by message passing. In the preceding example described with reference to FIG. 4, it is the previously questioning Graphics subsystem. The question went from Graphics to Data via a transaction and the answer is now to be sent from Data to Graphics. Once this second transaction has also been terminated, the record set of the results set should have arrived in the Graphics subsystem in order to be visualized. At the same time no specification was necessary at any point declaring that the source subsystem also has to be final destination system. Rather, it must have been agreed and specified as command-inherent information upon implementation of this command. The source is available in the question token as generally valid supplementary information. A condition can be derived from this information determining whether the answer is to be routed back again or whether a new destination is necessary. From this it can be seen that the commands are precisely the point in this architecture where the application specifics are addressed. For this reason it is advantageous, for the use of debugging or case tools, also to store a specification with the command codes. Since the string data type is used, it is very easy to forward this information as well when the routing database is called.

As the time in which the spur line exists is dependent to a major degree on the access speed to the routing database, there is great latitude here for design decisions. With systems that are not so expensive, it is possible, for example, to use simple files or, in Windows 2000, to use the InMemoryDataBase of the Com+ system. Where complex command structures on high-performance systems are involved, an Oracle DB can also be used.

In any event it is important that the entire process of information acquisition by the middle tier 12 is strictly divided into two. Although two transactions are then also involved, neither of the two is dependent on the command-specific problem in terms of the time it is blocked. This time lies completely between the two transactions and thus guarantees the asynchronicity between question and answer. This shifts the task of synchronizing the two transactions completely to the subsystems. Only here is it possible, for example, to resolve reciprocal overtaking of answers.

This is very favorable with regard to the requirement for high scalability. Generally, much better scaling is possible with many small and determinate blocking times than with the few and long-lasting times that occur in the familiar multi-tier model from the prior art. Another fact that comes into play here is that the different performance requirements are always met with one and the same piece of software, since, of course, the architecture remains unchanged and the computing performance is increased as a result of the use of a higher number of computers.

It is advantageous that a distribution of parts of the overall system to different computers down to the level of the components is possible.

However, the question/answer transactions must not necessarily be executed sequentially in time, as described here. At any moment, any subsystem can request services from any other. This is precisely where the strengths of this architecture lie. Because the transactions are divided into two, no data is blocked within a transaction. This happens entirely in the intervening time, and in the service-providing subsystem and not in the microkernel. The question of security should be negotiated between the subsystems at a higher protocol level. To this end, special messages can be envisioned to implement, for example, a three-way handshake.

However, since no data has to be protected against other calls, each component may keep multiple instances active simultaneously.

If a bottleneck is to be expected, on the assumption of a linear increase in resource consumption with the number of messages, an object broker such as MTS, COM+ or CORBA should be used. These reduce this linear dependence with the aid of just-in-time activation, object pooling, thread pools and load balancing.

Since the most important part, the communication between the subsystems, stays unchanged with the message passing, it remains transparent for the components whether they request a service in the same computer or across computer boundaries (for example: COM/DCOM). The simultaneously used microkernel permits this scaling approach even through to the subsystem.

As all features are implemented here, performance improvements can also be achieved here through the approach of distribution over multiple computers. New features, which are mostly associated with higher computing time requirements, can therefore be appended without the need for recompilation.

A requirement for easy adaptability is fulfilled by bringing out the specific commands into the routing database. The different requirement profiles are implemented by the individual adaptation of the routing database. It is also conceivable that a special tool be developed in order to visualize the abstract information in the routing database. Thus, extensions and maintenance activities on the system are possible without programming knowledge.

Since components are used as supporting software elements, and specific things such as features and algorithms are concentrated in the subsystems, an evolutionary form of further development is easily possible. The software modules concerned with the set of problems in question are present in the particular subsystem. Consequently, the old code can always continue to be reused in that it is simply called directly by the new code within the subsystem. The new subsystem is then inserted in the system, which, of course, notices nothing of the changes because the architecture is preserved.

A further variant on the reuse of old code is that complete applications are surrounded by a component envelope that handles data adaptations expected by this application. This procedure ensures that the old application represents a component externally and internally continues to work as though it were to be called directly by the operating system. If this component is now furnished with the standard interface of the architecture for subsystems, it can also be integrated as such by default. As a result, the old application receives the messages from the other subsystems, even if these were developed much later and are therefore better coordinated. Because of the microkernel there is also no need to position this old application in the rigid multi-tier structure.

In this way, the NetManager prior to Version 5.X could subsequently receive a middle layer which it can use as an object broker (MTS, COM+).

Because of the use of components it is easy to implement patching. If a component is recognized as flawed, it is the sole object to be modified and recompiled. The critical point is that care is taken here not to alter the unique characteristics of a component, its GUIDs. It is reinserted simply by overwriting the access path in the component management system (in the Registry in the case of Windows) or by overwriting the component on the hard disk. If it is ensured that it is not called at this time, this can also take place during ongoing operation.

In the middle layer 12 implemented according to the invention, the arguments of the functions are only copied or used to derive routing information. The receiving function can be represented by means of a C pseudo code as follows:

```
BSTR Ccomponent::bstrPassing ( BSTR category,
          BSTR subsystem,
          BSTR command-group,
          BSTR command,
          BSTR timestamp,
          BSTR control-field,
          BSTR origin,
          BSTR source-name,
          BSTR destination-name,
          BSTR user-data )
{
  .........
  return bstrResult;
}
, where BSTR is an MS COM-specific data type which represents
a string of specific length.
```

It is emphasized that the description of the network components relevant for the invention is categorically not to be understood as constraining. It is especially evident to an appropriate person skilled in the art that the concepts used are to be understood functionally and not physically. Accordingly, the components can also be implemented partially or completely in software and/or distributed over multiple physical facilities.

What is claimed is:

1. A method for controlling an application process in a distributed system, comprising:
providing at least one client;
providing at least one server, wherein
the system is organized according to a multi-tier model and includes at least one first presentation layer, a second layer and a third data layer, and
the second layer is organized as a microkernel-based client/server system; and
providing an interface formed as a message is specified between the first and second layer, with a server request including at least the following:
the client translates the server request into a message with the relevant arguments,
the client sends the message to the server,
the request is forwarded and processed in full, and
the result of the request is returned on the basis of the message.

2. The method according to claim 1, wherein the second layer and/or its components are configured for routing the server request.

3. The method according to claim 1, wherein the server request is subdivided into a first transaction, originating from the client to the server, and a second transaction, originating from the server to the client, and which are physically separate.

4. The method according to claim 1, wherein the client belongs to the first layer and the server belongs to the second and/or third layer.

5. The method according to claim 1, wherein the server, after processing the request, sends a result of the request to the calling client or to a different destination address.

6. The method according to claim 1, wherein addresses and/or return addresses for the server request are coded in the message.

7. The method according to claim 1, wherein the microkernel includes subsystems which belong to the second layer and/or third layer.

8. The method according to claim 1, wherein the server request nested, server requests.

9. The method according to claim 1, wherein a result of the request is returned on the basis of routing information included in the message.

10. The method according to claim 1, wherein the message comprises at least the following:
origin, in which the address of the client is coded,
source name, in which the address of the server to be called is coded, and
destination name, in which the return address for the result is coded.

11. The method according to claim 10, wherein origin and destination name correspond or are different.

12. The Method according to claim 1, wherein the message of the client from the first layer is sent to a root component of the microkernel of the second layer, which then forwards the message to a processing component.

13. The method according to claim 1, wherein the processing in the second layer is performed asynchronously with respect to the processing in the first and/or third layer.

14. The method according to claim 1, wherein one part of the client which communicates with the second layer is blocked for a time between the server call and transmission of the message or receipt of a confirmation.

15. The method according to claim 1, wherein multiple calls of multiple clients are stored in a queue which operates according to a FIFO principle.

16. The method according to claim 1, wherein the microkernel of the second layer includes multiple subsystems which are subdivided into one or more components.

17. The method according to claim 1, wherein the servers of the second layer is/are not required to administer request-related address information.

18. A client/server system for controlling and/or implementing an application process, comprising:
at least one client;
at least one server, wherein
the system is organized according to a multi-tier model and includes at least one first presentation layer, a second layer and a third data layer, and
the second layer is organized as a microkernel-based client/server system; and
an interface formed as a message is specified between the first and second layer, with a server request including at least the following:
the client translates the server request into a message with the relevant arguments,
the client sends the message to the server,
the request is forwarded and processed in full, and
the result of the request is returned on the basis of the message.

20. A computer program product having a computer-readable medium with computer program code elements, in which, after the computer program has been loaded, the computer causes the program to execute the following:
organizing the system according to a multi-tier model and including at least one first presentation layer, a second layer and a third data layer; and
organizing the second layer as a microkernel-based client/server system; and
providing a message specified between the first and second layer, with a server request including at least the following:
translating the server request into a message with the relevant arguments,
sending the message to the server,
forwarding and processing the request, and
returning a result of the request on the basis of the message.

21. A device for executing and/or organizing an application process in a distributed system, comprising:
at least one client;
at least one server, in which the system is organized according to a multi-tier model and comprises at least a first presentation layer, a second layer and a third data layer, wherein
the second layer is organized as a microkernel-based client/server system; and
an interface, in the form of a message, is arranged between the first and second layer, where the device for processing a server request comprises at least the following:
a message generation module which is configured to convert the server request into a message with relevant arguments,
a send module which is configured to send the message to the server,
a processing unit which forwards and processes the request, and
a return module which sends the result of the request back on the basis of the message.

22. The device according to claim 21, wherein the device has a computer architecture which is configured to execute the method in which the device executes:
organizing the system according to a multi-tier model and including at least one first presentation layer, a second layer and a third data layer; and
organizing the second layer as a microkernel-based client/server system; and
providing a message specified between the first and second layer, with a server request including at least the following:
translating the server request into a message with the relevant arguments,
sending the message to the server,
forwarding and processing the request, and
returning a result of the request on the basis of the message.
